(19) United States
(12) Patent Application Publication
(10) Pub. No.: US 2006/0249496 A1
(43) Pub. Date: Nov. 9, 2006

(54) Processing method and apparatus using laser beam

(75) Inventors: Hiroshi Morikazu, Tokyo (JP); Nobumori Ogoshi, Tokyo (JP); Koichi Takeyama, Tokyo (JP)

Correspondence Address: SMITH, GAMBRELL & RUSSELL, 1850 M STREET, N.W., SUITE 800, WASHINGTON, DC, 20036, US

(73) Assignee: Disco Corporation

(21) Appl. No.: 11/414,352

(22) Filed: May 1, 2006

(30) Foreign Application Priority Data
May 9, 2005 (JP) 2005-135773

(51) Int. Cl. B23K 26/08; B23K 26/067

(52) U.S. Cl. 219/121.73

(57) ABSTRACT

A processing method and apparatus using a laser beam, which can expel as much debris, produced upon application of a laser beam, as possible out of a workpiece to minimize the debris remaining on side surfaces of grooves. The processing method and apparatus superpose a first laser beam (30A) having a width D1 of a focal spot, and a second laser beam (30B) having a focal spot (32B) upstream, in a beam advancing direction, of the focal spot of the first laser beam, and having a width D2 of a beam spot at the focal spot of the first laser beam, D2 being larger than D1 (D2>D1); and apply the superposed laser beams to the workpiece.

### FIELD OF THE INVENTION

This invention relates to a processing method and apparatus using a laser beam and, more particularly, a processing method and apparatus which move a workpiece, such as a semiconductor wafer, and a laser beam relative to each other while applying the laser beam to the workpiece.

### DESCRIPTION OF THE PRIOR ART

In the production of a semiconductor device, for example, it is well known that many rectangular regions are defined by streets arranged in a lattice pattern on the face of a semiconductor wafer including a substrate, such as a silicon substrate, a sapphire substrate, a silicon carbide substrate, a lithium tantalate substrate, a glass substrate, or a quartz substrate, and a semiconductor circuit is formed in each of such rectangular regions. Then, the semiconductor wafer is divided along the streets to obtain the individual semiconductor circuits.

As methods and apparatuses for dividing the semiconductor wafer along the streets, processing methods and apparatuses using a laser beam have been proposed in recent times. JP-B 62-39539 and JP-A 6-120334 disclose processing methods and apparatuses which move a semiconductor wafer and a laser beam relative to each other along the streets on the face of the workpiece while applying the laser beam to the streets to form grooves along the streets on the face of the semiconductor wafer, and then exert an external force on the semiconductor wafer to rupture the semiconductor wafer along the grooves.

According to experiments conducted by the inventors, however, if the semiconductor wafer is divided to produce the individual semiconductor circuits by the above-described processing methods and apparatuses using a laser beam, the deflective strength of the products is relatively low. Such decreases in the deflective strength have been found to result from the following facts: Upon application of the laser beam to the workpiece, the workpiece is melted at the site of laser beam application. According to the conventional processing methods and apparatuses, so-called debris generated by melting is not fully removed from the workpiece, but adheres to and remains on the side surfaces of the resulting grooves, with the result that heat distortion due to heat transmitted from the debris is caused to the neighborhood of the grooves.

### SUMMARY OF THE INVENTION

It is a principal object of the present invention, therefore, to provide a processing method and apparatus using a laser beam, which can expel as much debris, produced upon application of the laser beam, as possible out of the semiconductor wafer to minimize the debris remaining on the side surfaces of the grooves, thereby avoiding or suppressing the generation of heat distortion due to the debris, and thus sufficiently avoiding or suppressing the decrease in the deflective strength of the workpiece.

According to the present invention, the above principal object is attained by superposing a first laser beam having a width D1 of a focal spot, and a second laser beam having a focal spot upstream, in a beam advancing direction, of the focal spot of the first laser beam, and having a width D2 of a beam spot at the focal spot of the first laser beam, D2 being larger than D1 (D2>D1), and applying the superposed laser beams to a workpiece.

According to a first aspect of the present invention, there is provided, as a processing method for attaining the above principal object, a processing method which moves a workpiece and a laser beam relative to each other while applying the laser beam to the workpiece, and comprising superposing a first laser beam having a width D1 of a focal spot, and a second laser beam having a focal spot upstream, in a beam advancing direction, of the focal spot of the first laser beam, and having a width D2 of a beam spot at the focal spot of the first laser beam, D2 being larger than D1 (D2>D1), and applying the superposed laser beams to the workpiece.

According to a second aspect of the present invention, there is provided, as a processing apparatus for attaining the above principal object, a processing apparatus comprising holding means for holding a workpiece, laser beam application means for applying a laser beam to the workpiece held on the holding means, and moving means for moving the holding means and the laser beam application means relative to each other, and

wherein the laser beam application means superposes a first laser beam having a width D1 of a focal spot, and a second laser beam having a focal spot upstream, in a beam advancing direction, of the focal spot of the first laser beam, and having a width D2 of a beam spot at the focal spot of the first laser beam, D2 being larger than D1 (D2>D1), and applying the superposed laser beams to the workpiece.

It is preferred that at the focal spot of the first laser beam, the beam spot shape of the first laser beam is an elliptic shape, the beam spot shape of the second laser beam is a circular shape, and the diameter of the circular shape is smaller than the major diameter of the elliptic shape and is larger than the minor diameter of the elliptic shape. It is advantageous to align the focal spot of the first laser beam with the face of the workpiece. Preferably, the laser beam application means includes a common laser beam source for generating a parallel laser beam, splitting means for splitting the laser beam from the laser beam source into the first laser beam and the second laser beam, nonparallel lens means for converting the second laser beam into a nonparallel laser beam, and focusing lens means for focusing the first laser beam and the second laser beam, and the focusing lens means is composed of a first cylindrical lens and a second cylindrical lens, the focusing directions of the first cylindrical lens and the second cylindrical lens being orthogonal to each other.

According to the processing method and apparatus of the present invention, the workpiece is melted by the application of the first laser beam and the second laser beam in the superposed state. Debris, which has been formed by the melting and is about to adhere to and remain on the side surfaces of the grooves, is expelled out of the grooves by the action of a widthwise outward portion of the second laser beam present beyond the width of the beam spot of the first laser beam. Thus, heat distortion due to remaining debris is avoided or suppressed. Consequently, the decrease in the deflective strength of the workpiece is fully avoided or suppressed.

### BRIEF DESCRIPTION OF THE DRAWINGS

FIG. 1 is a schematic view showing a preferred embodiment of a processing apparatus constructed according to the present invention.

FIG. 2 is a side view of a focusing means in the processing apparatus shown in FIG. 1.

FIG. 3 is an enlarged view showing the neighborhood of the focal spots of a first laser beam and a second laser beam in the processing apparatus shown in FIG. 1.

FIG. 4 is a schematic view showing the beam spot shape of the first laser beam and the beam spot shape of the second laser beam on the surface of a workpiece.

FIG. 5 is a sectional view showing a groove formed in the workpiece.

### DETAILED DESCRIPTION OF THE PREFERRED EMBODIMENTS

Preferred embodiments of the processing method and apparatus constituted in accordance with the present invention will be described in further detail by reference to the accompanying drawings.

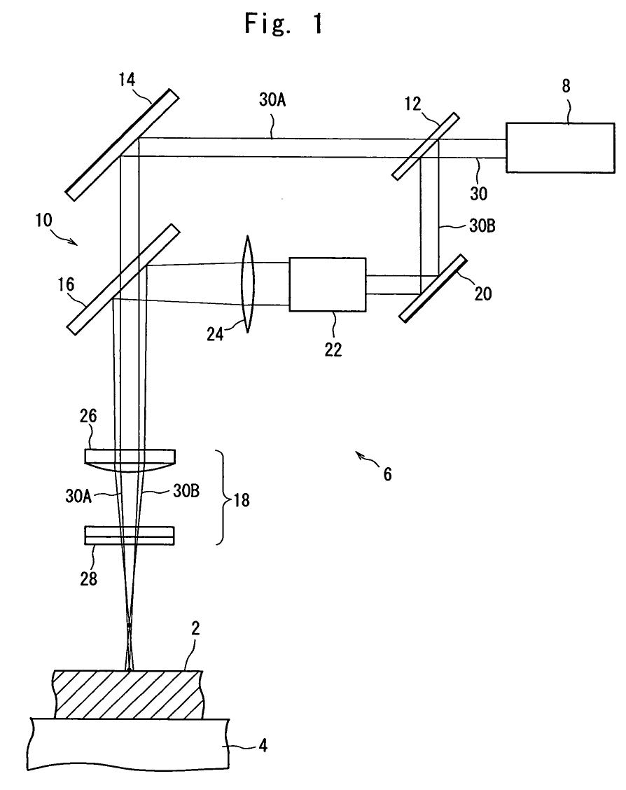

FIG. 1 schematically shows the preferred embodiment of the processing apparatus constructed according to the present invention. The illustrated processing apparatus is composed of a holding means 4 for holding a workpiece 2 such as a semiconductor wafer, and a laser beam application means indicated entirely at the numeral 6. The holding means 4 may be a vacuum attraction chuck which is composed of, for example, a porous member or a member having a plurality of suction holes and/or grooves, and which is brought into selective communication with a vacuum source (not shown). The holding means 4 is moved by a suitable drive means (not shown) in a right-and-left direction in FIG. 1 and a direction perpendicular to the sheet face of FIG. 1, and is also rotated about the axis of rotation extending in an up-and-down direction in FIG. 1. On the other hand, the laser beam application means 6 is moved in the up-and-down direction in FIG. 1, whereby the state of application of a laser beam to the workpiece 2 is adjusted.

The laser beam application means 6 in the illustrated embodiment is composed of a common laser beam source 8, and an optical means 10 for applying a laser beam delivered from the laser beam source 8 to the workpiece 2. The laser beam source 8 may be a YVO₄ pulsed laser or a YAG pulsed laser which generates a parallel laser beam, for example, with a wavelength of 532 nm, 355 nm or 266 nm. The repetition frequency of the laser beam may be 10 kHz, and its average output may be of the order of 3W to 5W.

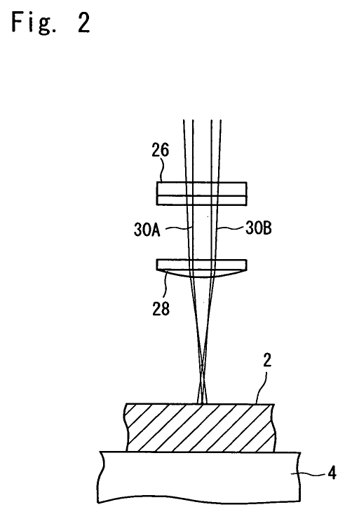

The optical means 10 for applying a parallel laser beam generated by the laser beam source 8 to the workpiece 2 includes a splitting means 12, which can be composed of a half mirror, a first reflecting mirror 14, a dielectric mirror 16, a focusing means 18, a second reflecting mirror 20, an expander 22, and a nonparallel lens means 24 which can be composed of a finely diameter-reducing lens. The focusing means 18 is composed of a first cylindrical lens 26 and a second cylindrical lens 28. As will be clearly understood by reference to FIG. 1 and FIG. 2 as a side view of the focusing means 18, the focusing direction of the first cylindrical lens 26 and the focusing direction of the second cylindrical lens 28 are orthogonal to each other. That is, the focusing direction of the first cylindrical lens 26 is the right-and-left direction in FIG. 1 and a direction perpendicular to the sheet face of FIG. 2, while the focusing direction of the second cylindrical lens 28 is the direction perpendicular to the sheet face of FIG. 1 and a right-and-left direction in FIG. 2.

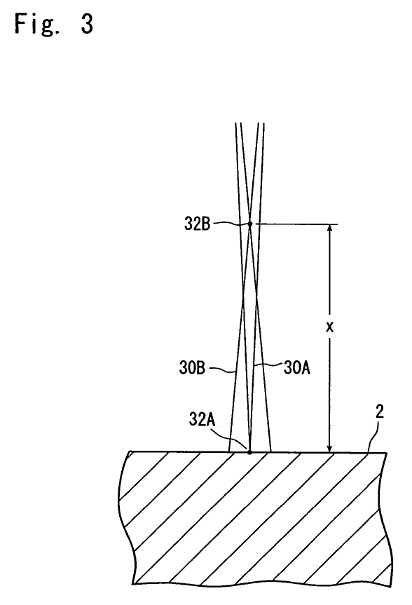

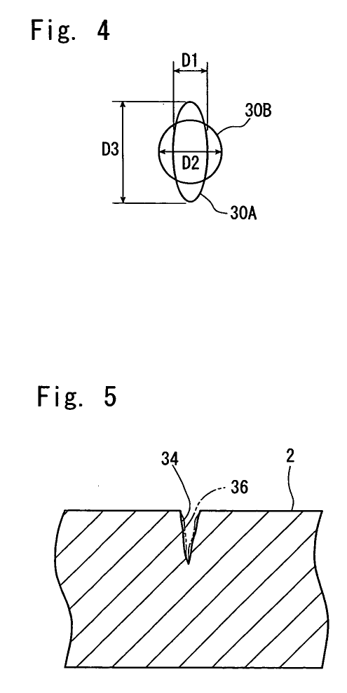

With further reference to FIG. 1, a parallel laser beam 30 projected from the laser beam source 8 is split by the splitting means 12 into a first laser beam 30A and a second laser beam 30B. Then, the first laser beam 30A is reflected by the first reflecting mirror 14, passed through the dielectric mirror 16, and entered into the focusing means 18. Then, as is clearly illustrated in FIG. 3, the first laser beam 30A is focused to a focal spot 32A by the focusing action of the first cylindrical lens 26 and the second cylindrical lens 28 of the focusing means 18. A beam spot shape at the focal spot 32A is an elliptic shape having a minor diameter (width) D1 and a major diameter (length in a direction of relative movement) D3, as shown in FIG. 4. Advantageously, the minor diameter D1 is of the order of 15 μm, and the major diameter D3 is of the order of 200 μm. The focal spot 32A of the first laser beam 30A preferably lies on the face of the workpiece 2 or the neighborhood of the face.

On the other hand, the second laser beam 30B is reflected by the reflecting mirror 20, and entered into the expander 22 to be increased in the beam diameter by the expander 22. Then, the second laser beam 30B is incident on the nonparallel lens means 24 to be converted into a nonparallel laser beam progressively decreasing in diameter toward the front in the advancing direction. Then, the second laser beam 30B is reflected by the dielectric mirror 16 and entered into the focusing means 18. As is clearly illustrated in FIG. 3, the second laser beam 30B is focused to a focal spot 32B by the focusing action of the first cylindrical lens 26 and the second cylindrical lens 28 of the focusing means 18. It is important that the focal spot 32B of the second laser beam 30B be located upstream, in the beam advancing direction, of the focal spot 32A of the first laser beam 30A by a predetermined distance x. The distance x may be of the order of 20 μm. The beam spot shape of the second laser beam 30B at the focal spot 32B is a circular shape. The second laser beam 30B further advances from the focal spot 32B, is superposed on the first laser beam 30A, and is projected to the face of the workpiece 2. During this process, as the second laser beam 30B goes farther from the focal spot 32B, its beam spot diameter is progressively increased. At the focal spot 32A of the first laser beam 30A, the beam spot of the second laser beam 30B has a circular shape of a diameter (width and length) D2. At the focal spot 32A of the first laser beam 30A, the beam spot diameter D2 (i.e., width) of the second laser beam 30B is importantly larger than the aforementioned minor diameter D1 (i.e., width) of the beam spot of the first laser beam 30A, and is preferably smaller than the aforementioned major diameter D3 of the beam spot of the first laser beam 30A. The diameter D2 of the beam spot of the second laser beam 30B may be of the order of 20 μm.

When the holding means 4 holding the workpiece 2 is moved in the right-and-left direction in FIG. 1, with the first laser beam 30A and the second laser beam 30B being applied to the face of the workpiece 2 in the above-described manner, a groove 34 having a sectional shape as illustrated in FIG. 5 and extending in the right-and-left direction in FIG. 1 is formed in the face of the workpiece 2. The formation of the groove 34 will be described in further detail. According to the processing method and apparatus constituted in accordance with the present invention, the face of the workpiece 2 is melted in the region of superposition of the first laser beam 30A and the second laser beam 30B to form the groove 34. Debris generated by the melting of the workpiece 2 is about to adhere to the side surface of the groove 34 and remain there. However, a widthwise outward portion of the second laser beam 30B present beyond the width of the beam spot of the first laser beam 30A acts on the debris, which is about to adhere to the side surface of the groove 34 and remain there, thereby effectively expelling the debris outside. Thus, the groove 34, where the adhesion and remaining of debris have been fully avoided or suppressed, is formed, so that the generation of heat distortion due to debris can be fully avoided or suppressed. The workpiece 2 having the grooves 34 formed therein can be broken along the grooves 34 by exerting an external force, as appropriate, on the workpiece 2.

If, on the other hand, the laser beam 30 from the laser beam source 8 is not split into the first laser beam 30A and the second laser beam 30B, but is caused to be incident on the focusing means 18 via the first reflecting mirror 14 and the dielectric mirror 16, for example, and is applied to the workpiece 2, there is a tendency that debris 36 adheres to the side surface of the groove 34 and remains there, as indicated by a dashed double-dotted line in FIG. 5.

While the preferred embodiments of the present invention have been described in detail by reference to the accompanying drawings, it is to be understood that the invention is not limited to such embodiments, but various changes and modifications may be made without departing from the scope of the invention.

What we claim is:

1. A processing method which moves a workpiece and a laser beam relative to each other while applying the laser beam to the workpiece, and comprising:
superposing a first laser beam having a width D1 of a focal spot, and a second laser beam having a focal spot upstream, in a beam advancing direction, of the focal spot of the first laser beam, and having a width D2 of a beam spot at the focal spot of the first laser beam, D2 being larger than D1 (D2>D1); and
applying the superposed laser beams to the workpiece.

2. The processing method according to claim 1, wherein at the focal spot of the first laser beam, a beam spot shape of the first laser beam is an elliptic shape, a beam spot shape of the second laser beam is a circular shape, and a diameter of the circular shape is smaller than a major diameter of the elliptic shape and is larger than a minor diameter of the elliptic shape.

3. The processing method according to claim 1, further comprising aligning the focal spot of the first laser beam with a face of the workpiece.

4. A processing apparatus comprising holding means for holding a workpiece, laser beam application means for applying a laser beam to the workpiece held on the holding means, and moving means for moving the holding means and the laser beam application means relative to each other, and wherein
the laser beam application means superposes a first laser beam having a width D1 of a focal spot, and a second laser beam having a focal spot upstream, in a beam advancing direction, of the focal spot of the first laser beam, and having a width D2 of a beam spot at the focal spot of the first laser beam, D2 being larger than D1 (D2>D1), and applies the superposed laser beams to the workpiece.

5. The processing apparatus according to claim 4, wherein at the focal spot of the first laser beam, a beam spot shape of the first laser beam is an elliptic shape, a beam spot shape of the second laser beam is a circular shape, and a diameter of the circular shape is smaller than a major diameter of the elliptic shape and is larger than a minor diameter of the elliptic shape.

6. The processing apparatus according to claim 4, wherein the laser beam application means aligns the focal spot of the first laser beam with a face of the workpiece.

7. The processing apparatus according to claim 4, wherein the laser beam application means includes a common laser beam source for generating a parallel laser beam, splitting means for splitting the laser beam from the laser beam source into the first laser beam and the second laser beam, nonparallel lens means for converting the second laser beam into a nonparallel laser beam, and focusing lens means for focusing the first laser beam and the second laser beam, and the focusing lens means is composed of a first cylindrical lens and a second cylindrical lens, focusing directions of the first cylindrical lens and the second cylindrical lens being orthogonal to each other.
